(19) United States
(12) Patent Application Publication
(10) Pub. No.: US 2012/0072946 A1
(43) Pub. Date: Mar. 22, 2012

(54) CUSTOMIZED BARKER CHANNELS FOR VIEWERS OF A CABLE SYSTEM

(76) Inventors: Kevin Cranman, Atlanta, GA (US); Charles Dasher, Lawrenceville, GA (US); William Brown, Cumming, GA (US)

(21) Appl. No.: 12/883,333

(22) Filed: Sep. 16, 2010

(51) Int. Cl. H04N 7/173; H04N 7/025; H04N 7/16

(52) U.S. Cl. 725/28; 725/97; 725/34

(57) ABSTRACT

A barker management system provides customized barker channels to a viewer, where the barker management system may be integrated into a VOD service. In one embodiment, the headend is informed when the viewer requests the VOD service and is further informed of a set top box (“STB”) identifier. The headend ascertains a rating of a barker channel, and may create a playlist of trailers having a compatible rating and streams the trailers on the barker channel to the SIB. The STB is informed which channel to use, and generates a display with the barker channel presented in one window of the display, while the VOD menu selections are presented in another window of the display. The selection of trailers in the barker channel can be based on ratings, content, or other criteria. The headend can statically or dynamically generate various customized barker channels for viewers.

### BACKGROUND OF THE INVENTION

1. Field of Invention

The present invention generally pertains to barker channels in a video delivery system, where the contents of the barker channels are customized for specific viewers.

2. Prior Art

A “barker channel” can refer to a television channel on a cable system that is dedicated to informing and promoting programming available to subscribers of the cable system. The name is likely derived from a circus barker, which is an individual shouting to passers-by promoting circus acts and encouraging them to enter a circus side show. The barker channel likewise informs and encourages viewers to sample video programming offered by the cable service provider. In many cases, the featured video programming comprises video on-demand (“VOD”) programming available from the cable service provider (“CSP”).

In some instances, the barker channel can be displayed as any other cable channel. Namely, the barker information can be selected and displayed as a conventional channel, where the information is displayed over the entire television screen. In other instances, the barker channel is incorporated with another service, such as a VOD service. Specifically, the set top box may process the barker channel such that the barker channel is reformatted to fit within a portion of the display (a “window”) and presented with other information from the video service provider, such as electronic program guide information or VOD menu selections. The program being “barked” is provided as a preview to encourage the viewer to select/purchase the content.

One typical format of a display incorporating a barker channel processed in this manner is shown in FIG. 1, which depicts the prior art. In FIG. 1, the display 100 of a television screen is depicted as comprising three separate areas or “windows.”. One window in the upper right corner 110 displays the barker channel providing previews of an available program. Often times, these previews (a.k.a. “trailers”) comprise selected portions of the program itself. In FIG. 1, another window in the upper left portion of the television screen 120 may include general information about the VOD service. This information may include the time, name of the cable service provider, etc. Another window 130 may offer categories (or other content related information) of movies in the VOD library offered by the cable service provider. Upon the viewer's selection of a category, which is typically accomplished by using a remote control unit, the contents of the window panel 120 and 130 may change appropriately (no shown). For example, the information in window 130 may change to present various movies titles in a selected category. Upon selecting a particular movie title, information in window 120 may be replaced with the selected program's information. The program's information may include program specific information such as the actors, directors, year produced, rating information, and purchase price.

Typically, the set top box generates the display 100 by combining real-time streamed content (provided via the barker channel) with locally generated content based on data stored in memory (the VOD selection menus). Other applications involving the barker channel include providing electronic program guide information. In this application, the barker channel is similarly provided in a first window of the display, and program guide information is provided in a second window. The set top box similarly combines the barker channel with locally stored channel guide information to create the resulting display.

Returning to FIG. 1, the trailer shown in window 110 from the barker channel is continuously presented to the viewer even while the user is selecting menu options. The presentation of the trailer, is independent of the particular category and movie selected by the viewer. Thus, the trailer shown in window 110 may be depicting violent action scenes of a recently released action program, even while the viewer has selected and is searching for titles in a “Kids Friendly” menu category. Other such mismatched or inappropriate content may be presented, which can vary based on the household and viewers. In some circumstances, there can be a significant mismatch in interests of the viewer and the content of the trailer presented in the VOD. Thus, there is a need for selecting the contents of the barker channel in a manner that is more compatible with the interests, desires or demographics of the viewer accessing services that incorporate the barker channel.

### BRIEF SUMMARY OF THE INVENTION

In one embodiment, a system provides customized barker content to a subscriber of a video service provider, comprising a set top box (“STB”) connected to a video distribution system of said video service provider, said STB configured to provide signals to a television to present a display associated with a video on-demand (VOD) service wherein said display comprises a first portion comprising a movie trailer and a second portion comprising VOD menu selections, a headend configured to stream a plurality of barker channels on a video distribution network, wherein one of said barker channels comprises said movie trailer, said headend comprising a processor configured to (a) receive a set top box identifier uniquely identifying said set top box, said STB identifier associated with said subscriber, (b) cause said movie trailer to be streamed over said video distribution network on one of said plurality of barker channels, wherein said one of said plurality of barker channels is associated with a barker channel identifier, (c) inform said STB of said barker channel identifier and a data store, said data store storing said plurality of movie trailers, wherein said processor causes said data store to provide said movie trailer to said video distribution system.

In another embodiment, a method provides a customized barker content to a set top box of a subscriber of a video service subscriber, wherein said STB is configured to generate signals to a television for a display having a first portion presenting a movie trailer and a second portion presenting VOD menu selections, said method comprising the steps of (a) receiving a signal at a headend of the video service provider sent from the STB over a video distribution indicating a set top box identifier, wherein said signal is sent in response from said subscriber requesting a video on-demand service, (b) selecting said movie trailer from a data store comprising a plurality of movie trailers having a plurality of ratings, (c) causing said movie trailer to be streamed from said headend over one of a plurality of barker channels, and (d) providing to said STB from said headend a barker channel identifier associated with the one of the plurality of barker channels, wherein said STB generates said display by accessing said barker channel using said barker channel identifier.

The above embodiments are only two of the various embodiments described herein, and are not intended to limit the scope of the claims herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a prior art screen display of a service incorporating a barker channel;

FIG. 2 illustrates one embodiment of a system architecture incorporating a barker management system;

FIGS. 3A and 3B illustrates one embodiment of the concepts of static and dynamic barker channels;

FIG. 4 illustrates one embodiment of the processing occurring in a service provider's headend for providing customized barker channels;

FIG. 5 illustrates one embodiment of the headend's determination of a rating associated with a customized barker channel for a viewer;

FIG. 6 illustrates one embodiment of providing a customized barker channel for a viewer;

FIG. 7 illustrates one embodiment of a message flow for providing a customized barker channel to a set top box;

FIG. 8 illustrates another embodiment of a message flow for providing a customized barker channel to a set top box;

FIG. 9 illustrates one embodiment of the architecture of the barker management system;

FIG. 10 illustrates another embodiment of the architecture using SCTE 130 compatible components;

FIG. 11 illustrates another embodiment of an architecture using SCTE 130 compatible components; and

FIG. 12 illustrates yet another embodiment of architecture using SCTE 130 compatible components.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including, but not limited to: technology based on hard disks, CD-ROMs, optical storage devices, solid state storage or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

Many cable service providers (“CSPs”) generate a barker channel where the content comprises selected movie trailers for the purpose of promoting programming content to their viewers. Typically, the promoted programs are movies, but can include other content. For simplicity of illustration, it will be assumed that the programming comprises movies, although the programming can comprise other types of content. In some embodiments, a dedicated cable system channel showing the barker channel can be provided to viewers (such as a “pre-view” channel). However, in other embodiments, the barker channel is incorporated with other CSP services wherein the barker channel is shown in a portion of the display along with other information, such VOD menu selections or program guide information.

For example, many CSPs provide a VOD service allowing a subscriber to view a movie that is streamed to the set top box (“STB”) at the request of the subscriber. The CSP typically has a number of movies available for selection, and a menu structure is defined to facilitate the subscriber's selection by presenting the titles in a defined manner. Various menu structures, searching engines, and/or preference algorithms may be used. Further, various categories can be defined, along with sub-menus of individual movies.

Typically, when accessing the VOD service, only a portion of the display area is used to present these menu choices to the subscriber. Portions of the display can be referred to as a window pane or window. A window may be used to provide information regarding a particular movie, price, content, rating, etc. In many cases, another window is dedicated to providing the barker channel (albeit on a reformatted basis). Hence, this window can be referred to as the barker channel, or simply “the barker.” In the case of the VOD service, the barker channel is presented simultaneously with the VOD menu options. As used herein, reference to the barker content (or barker) can refer to (1) the contents of the barker channel by itself on a standalone basis or (2) to the contents of the barker channel as integrated with another service, such as VOD service or electronic program guides.

The barker content comprises movie trailers (“trailer”) is a promotional video, which may be extracted video segments from a featured program or is a specifically produced video. For illustration purposes, the program used to exemplify the invention is a movie, although the program can be of various types and is not limited to a movie. In other instances, the video segments are specifically produced video segments, which are typically a few minutes in length. As well known, trailers often incorporate scenes of dramatic climax, adventure, dialogue, and/or action designed to attract interest of the viewer, and interest the viewer to purchase or otherwise view the movie. Not surprisingly, trailers themselves may be rated according to their content, based on the Motion Picture Association of America (“MPAA”) rating (e.g., G, PG, PG-13, R, and NC-17). Thus, the “rating” of a trailer typically refers to one of the above well known MPAA categories. The rating of the movie is distinct from the rating of the trailer. For example, it is possible for a movie to have an R rating, but the trailers featuring the movie having a PG rating.

Typically, the barker comprises a series of trailers thereby promoting of a number of programs. Often, the content of the barker is repeated, and is updated periodically by the CSP as new trailers are made available. The trailers in a barker may have different ratings, and may feature a G rated trailer followed by an R rated trailer.

However, this arrangement has several deficiencies. First and foremost, the contents of the barker may be inappropriate for the immediate viewing audience. For example, a family selecting the VOD service and perusing the VOD menu options for “G” rated movies may be subjected to viewing R rated trailers. Alternatively, family members may be subjected to viewing a PG or PG-13 rated trailer for an R rated movie that the parents in the family do not want their family members to view. Because the barker channel is incorporated by the STB into the VOD service, it is inescapable that the viewer selecting the VOD service will be presented with the barker contents. Even viewing a brief or limited portion of a trailer on the barker may be objectionable to parents accessing the VOD service with small children. For this reason, parents may opt out from accessing the VOD service.

While the CSP could create the barker to feature only “G” rated trailers, doing so forecloses the possibility of promoting non-G rated programs. Thus, “defaulting” to a G rated barker does not suit the goals of the CSP in promoting the widest array of available movies.

In general, the present approach does not tailor the barker channel to any particular subscriber, but attempts to appeal to the mass audience. If the barker contents were tailored to a particular subscriber, for example taking in account the viewer's past habits, the barker channel would be more effective in promoting programs to subscribers. Thus, in various embodiments of the invention, customized barker channels can be provided to subscribers of a cable system.

### Subscriber Association With A Barker Channel Rating/Content Preference

In order to provide suitable barker content to a subscriber, information can be maintained or derived by the video service provider indicating which rating level or barker content should be associated with a subscriber. For purposes of illustration, the information comprises rating criteria, but it should be appreciated that the information may comprise content related information. The content of the trailer refers to information such as the type of movie (e.g., comedy) or subject matter (e.g., football). The rating level associated with a subscriber may be static (e.g., changes infrequently, or not at all), or may be dynamic (continuously updated), or some level in-between. The distinction between “static” and “dynamic” with respect to a subscriber's barker rating preference is relative, as will be seen.

In one embodiment of the invention, the user indicates a barker rating preference when establishing cable service, which can be done in a number of ways. In one embodiment, the subscriber indicates a rating preference at service establishment to a customer service representative who provisions the value. Alternatively, the subscriber could provide their rating preference by accessing a web site operated by the service provider, accessing an interactive voice response system, or interacting with a set up menu displayed by the television generated by the STB. Responses can be indicated using the remote control, STB control inputs, or other suitable means.

In one embodiment, once the rating value is established, it is used thereafter by the CSP until the value is changed by the subscriber. It is possible that whatever means were provided to a subscriber for initially establishing a barker channel rating could be used to allow the subscriber to alter or update the value. It is also possible that different means could be allowed to associate the subscriber with an updated rating preference.

In another embodiment of the invention, the CSP may automatically initially determine, or automatically update, the barker channel rating preference of a subscriber. This can provide a relatively dynamic level of rating information and the viewer may not even be aware of this process. This can be done in a number of ways.

First, the rating could be based on analyzing prior programming selections of the programming selections which originated from that STB. A subscriber that has historically selected and viewed G or PG rated programming can be associated with a barker channel rating of G or PG. Alternatively, a moving average can be used to determine the barker rating (e.g., by analyzing the ratings of the last six movie selections from this subscriber). Other variations can involve time-of-day, and/or day-of-week considerations. For example, if R rated movies are only selected by the subscriber on a Friday/Saturday evening, then this information can be used to associate the viewer with a particular rating based on when the user requests the VOD service. The information of a subscriber's past viewing selections can be stored in a viewing log database or billing database accessible by the headend.

Second, the CSP can use other information, such as demographic information, to determine which rating to associate with a subscriber. Thus, subscribers in an urban or metro serving area having a certain age demographic may be assigned an R rating, whereas subscribers in a suburban service area may be assigned a PG-13 rating. Any number of external factor's, including age, income, sex, marital status, etc. can be used to assign a barker rating to a subscriber.

Third, the CSP may use other information provided in conjunction with the VOD request to associate the subscriber with a rating. For example, the VOD menu structure may be designed to allow the subscriber to select a particular category of available movies. The presently selected category can be indicated to the headend and used to influence the rating of the barker channel. For example, if the “comedy” category is selected from the VOD menu, then the rating could be set to a certain level (e.g., PG-13). If a “family” category is selected, then the rating could be set to G. Finally, if “drama” is selected, the rating could be set to R. Thus, the type of trailers presented on the barker channel could be dynamically determined based on the present category selections by the subscriber. The information about which selections were made by the subscriber can be combined with other information, such as time, day, demographics, etc. A variety of algorithms can be defined which use these inputs to select which rating, content, or other type of trailer would be presented to the viewer.

In other embodiments, information about which channels a viewer selected or accessed using an electronic program guide can be sent to the headend and analyzed. For example, a viewer selecting information on a program guide about upcoming children's programs could be analyzed to determine that the rating or content of the barker channel should be customized to provide G or children friendly content. In other embodiments, information about a particular channel selected by the viewer could be used to provide a trailer to the viewer promoting that particular movie.

It is possible to also combine these approaches for a subscriber. For example, an initial determination of a barker channel rating value that is set for the subscriber may be determined using a static approach, and then after a period of time where sufficient viewing data is obtained, a dynamic approach can be incorporate for determining the barker rating. Alternatively, the video service provider can periodically (e.g., every 6 months) analyze viewing history and related information to determine whether to alter the rating information for a subscriber. One skilled in the art will be able to create a number of alternatives while keeping with the principles of the present invention.

### Basic Architecture

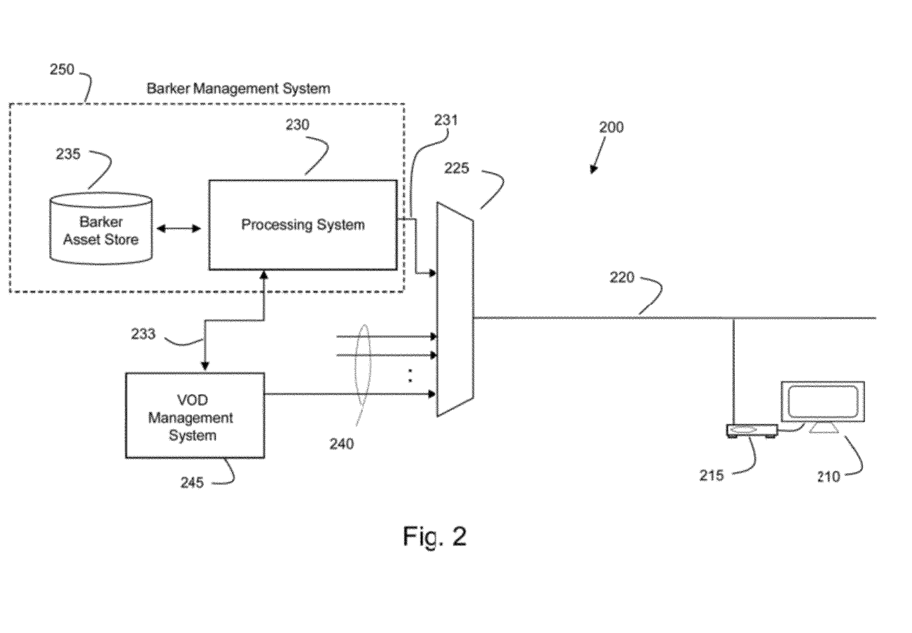

One embodiment of the architecture for operating the present invention is shown in a simplified manner in FIG. 2. FIG. 2 shows a system 200 comprising a television set 210 connected to a set top box 215, which can receive various channels delivered to it over the cable distribution network 220. In this embodiment, the STB 215 receives various VOD data, which is maintained in memory of the STB. Further, the STB receives a barker channel transmitted over the distribution network 220, and processes the barker channel and the VOD data to generate an appropriate multi-windowed display.

The cable distribution network is shown as a linear bus, but the actual implementation of the cable distribution network can occur using various topologies and technologies. Thus, the cable distribution network could be a series of interconnected fiber-optic rings, hybrid coax-fiber network arrangements, etc., using a variety of communication technologies, including IP based protocols. Further, although this embodiment is illustrated using a cable distribution network, other embodiments can employ the principles of the present invention, and include those video service providers using satellite video transmission, IPTV, wireless local transmission, cellular based services, local fiber-optic transmission and other types of communication technologies.

The headend is a term broadly used herein to refer to the equipment providing the signals to the video distribution network. This can be applicable to cable and non-cable service providers. In FIG. 2, this would include multiplexor 225 which receives various inputs and generates the multiplexed channels onto the cable distribution system 220. For purposes of illustrating an embodiment of the present invention, the inputs to the multiplexor are divided into two types of inputs. Inputs 240 represent regular (non-barker) programming channels, which can originate from various conventional video sources. These may include programming received from broadcast stations, satellite feeds, or even from a VOD management system 245. For purposes of illustration, these channels do not include the barker channels. Rather, the barker channels are shown as a separate input 231 to the multiplexor.

The barker channels are provided from a Barker Management System (“BMS”) 250. This is shown in one embodiment as comprising a processing system 230 interacting with a barker asset store 235 (database). In one embodiment, the BMS obtains the content in the form of trailers, stores the content in the barker asset store, and then forms a playlist of content for the barker channel to then stream out over the cable distribution network. In some embodiments, the processing system 230 actually streams out the barker channel, whereas in other embodiments, the processing system 230 may direct another component or system to stream out the barker contents. The BMS performs other functions, as will be seen. The BMS typically will generate a plurality of barker channels.

In certain embodiments, the BMS may be integrated or communicates with the VOD Management System 245 as shown by line 233 in FIG. 2, or with other headend components. Thus, it is not required that the BMS 250 be implemented as a distinct system from other systems, such as the VOD Management System 245. For example, in some embodiments the video service provider may have an asset management system for capturing, managing, storing, and retrieving video assets (e.g., video programs). The trailers can be stored in the asset management system. The BMS processing system can be implemented using the asset management system by providing a suitable software upgrade to perform the required functions.

One of the functions of the BMS is to generate the customized barker channel, and in various embodiments, the BMS typically generates a plurality of barker channels. A number of embodiments are possible for realizing the functions.

Static vs. Dynamic Barker Channels

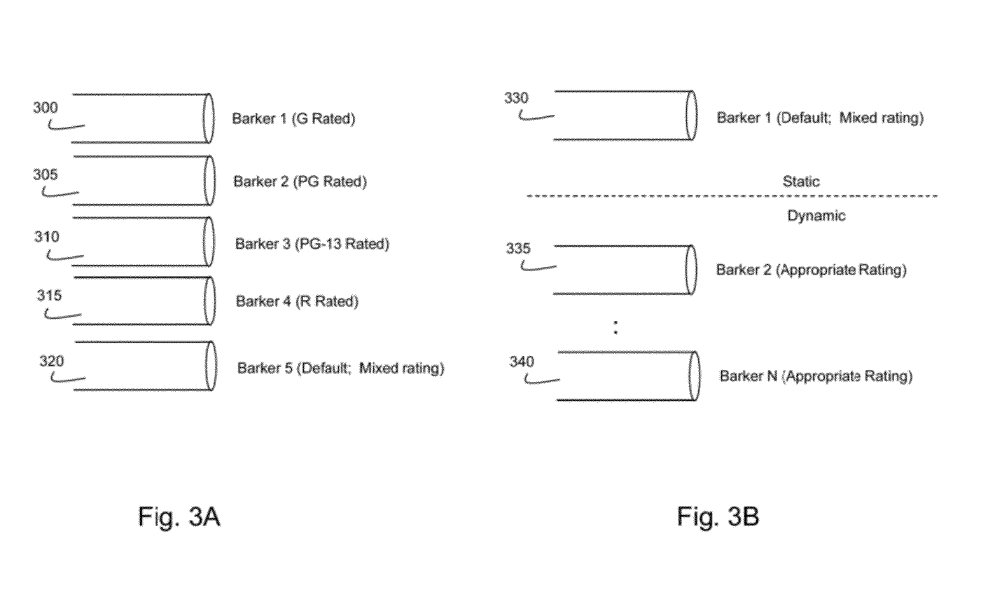

There are two main arrangements of providing barker channels over the cable distribution network. These are illustrated in FIG. 3A and FIG. 3B. In FIG. 3A a fixed number of barker channels are generated and streamed (or caused to be streamed) by the BMS over the distribution network. In this embodiment, five barker channels 300, 305, 310, 315, and 320 are provided. Barker channel #1 300 is comprised of content that is G rated. Barker channel #2 305 is comprised of content that is PG rated. Barker channel #3 310 is comprised of content that is PG-13 rated, and Barker channel #4 315 is comprised of content that is R rated. The last barker channel, barker channel #5 320 is comprised of mixed content, and can be a default or existing barker channel.

In various embodiments, the number of barker channels and their associated rating may vary, as not all ratings are required to be present on the video distribution system. (Indeed, in the embodiment of FIG. 3A, no NC-17 rated barker channel is shown.) Further, the content in a particular barker channel may not be limited to content in just that one rating, but may include contents rated in a “lesser” category. For example, a PG-13 rated barker channel may also include content that is rated G or PG, but it would not include R rated content. In this example, G is rated lesser than PG, which in turn is rated lesser than PG-13, etc. Thus, a “rating” could be considered cumulative of the “lesser” ratings.

In this embodiment, the barker channels are continuously provided. Thus, in the embodiment of FIG. 3A, all five barker channels are generated and streamed over the cable distribution network. Thus, this type of arrangement can be called “static” because various rated barker channels are always provided. There is more than one barker channel provided (otherwise, every viewer would receive the same barker channel and there would be no customization). However, there can be as few as two barker channels, or as many as the CSP desires to provide.

The default barker channel 320 is not always required to be provided in a static barker channel arrangement, but is shown in this embodiment as a barker channel having a mix of rated trailers. The default barker channel would be provided in instances where, for example, a STB is not associated with a specific barker channel, or if there is a delay in providing a customized barker channel. In other embodiments, a particular rated barker channel (e.g., PG) could also function as a default barker channel. Thus, in one embodiment, providing two barker channels—one PG-13 rated and one R rated—could represent one embodiment of the invention.

The maximum number of barker channels that can exist in a static arrangement is not limited to five channels, as shown in FIG. 3A. The CSP may opt to provide multiple barker channels of a given rating. For example, a CSP can provide one PG-13 rated barker channel featuring recently released comedy trailers. Another PG-13 rated barker channel could feature drama trailers. Another PG-13 rated barker channel could focus on science-fiction content. Thus, there could be a number of duplicative barker channels with the same rating, but a different content focus. The CSP could alternatively selectively combine the content of the trailers based on demographic or other criteria. Other embodiments are possible where barker channels directed to specific content are provided (e.g., the “sci-fi” barker channel) which is not limited by rating.

### Dynamically Generated Barker Channels

The other type of barker channel that can be provided is a dynamically generated barker channel. A dynamically generated barker channel generally refers to a channel which is created for a particular viewer, and is not provided absent a viewer's request. There are two types of dynamically generated barker channels—one is headend generated and the other is set top box generated.

Headend dynamically generated barker channels are illustrated in FIG. 3B as barker channels 335, 340. These channels are generated in real time by the BMS for users as needed. Typically, in one embodiment, the barker channel is provided when a viewer selects to view VOD programming. If there are no active VOD requests from viewers, then there is no requirement to dynamically generate a barker channel iii the headend. If there are several active VOD requests, then there may be a plurality of barker channels generated by the headend. The number of barker channels created for N requests can be N or fewer. For example, if there are two VOD requests, and thus there are two viewers requiring a custom barker channel, it is possible that both viewers would receive an identically rated barker channel. For example, both viewers may receive a G rated barker channel. Thus, it would only be necessary to create one barker channel. This barker would be dynamically generated for the first viewer, but could then be “reused” for the second viewer. On the other hand, the CSP may generate two different barker channels, with different ratings, one for each viewer. Thus, a customized barker channel does not necessarily require a unique barker channel for each viewer. When both viewers are done accessing the VOD service, the dynamic barker channel would not be required, and it would cease to be streamed.

As with the static channels, the CSP may generate two distinct barker channels, even though the rating is the same. The selection of trailers for each viewer (i.e., the content of the trailers) can be tailored for that particular viewer. As will be seen, there are various ways in which this can be done. This would allow two separate cable subscribers to both receive a PG-13-rated barker channel, but one could receive a barker channel featuring comedy trailers while another could receive trailers featuring recently released action-oriented programming trailers.

Unlike the static barker channels which are continuously provided, dynamically generated barker channels typically have a limited duration. For example, a viewer invoking the VOD service may take a few minutes to browse the available content in the VOD menus, and then make a selection. However, it is expected that in the vast majority of cases, a selection would be made within 5 to 15 minutes after invoking the VOD service. Thus, when a dynamic barker channel is created, it will involve defining a series of trailers representing 5-15 minutes of viewing time. The series of trailers is called a “playlist.” Although the playlist may only represent 5-15 minutes of viewing time, the contents can be repeated after the last trailer is presented. Thus, if a viewer happens to leave the VOD menu up and running, the barker channel will be continuously played, but the contents will be repeated on a periodic basis. The duration of the playlist can be shorter, or longer, and typically can be set by the CSP using an administrative interface to the BMS.

FIG. 3B also illustrates a statically provided default barker channel 330. This channel can be provided in case a STB does not receive a dynamically provided barker channel, or there is some error preventing the BMS from generating a dynamic barker channel for a viewer. Consequently, this barker channel is a type of fail-safe or default barker channel so that a user can view the default barker channel until the dynamic barker channel is provided. In some embodiments as will be seen, the BMS may not immediately generate a customized barker channel for a viewer, and in the interim, the viewer can be provided with the default (static) barker channel. The provision of the default barker channel is not required to practice the principles of this invention, though.

As evident from the above, there is a distinction between statically and dynamically determining the rating associated with a viewer, versus statically and dynamically providing barker channels over the video distribution network. The former involves how a rating level is associated with a user, and the latter involves how barker channels with various rating levels are provided.

### Set Top Box Dynamically Generated Barker Channels

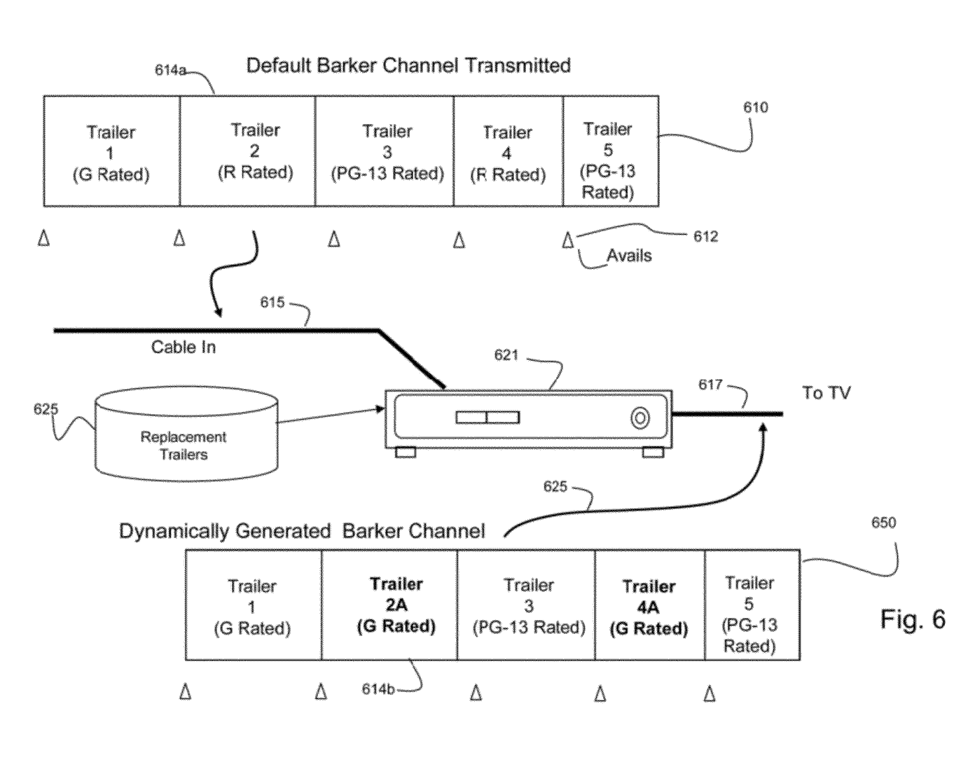

Another form of dynamically generated barker channel involves the STB generating portions of the barker channel. In one embodiment, the set top box dynamically generates a barker channel by selectively replacing trailers in the barker channel. The headend generates and transmits a single barker channel to all STB. Provided within each barker trailer is information identifying the rating of the trailer, as well as markers, called avails, which delineate the trailers. The STB then replaces the trailers as necessary so that all trailers have the desired rating. This is illustrated in FIG. 6. In FIG. 6, the default barker channel 610 is shown as a series of trailers, each of which includes data identifying a rating for a trailer, as well as avails 612 which delineate the trailers. The STB 621 receives the default barker channel on its input 615, and may store it in memory. Upon accessing the VOD service, the STB accesses the barker contents and streams the trailers, replacing the trailers as required to maintain the desired rating.

The STB also has a hard disk 625 storing replacement trailers which can be periodically transmitted to the STB. Based on a rating level maintained in the STB memory, the each trailer in the default barker is examined, and replaced if it exceeds the rating level. For example, the second trailer 614a in the default barker is R rated, and the STB replaces this with a G rated trailer 614b to form the dynamically generated barker content 650, which is then streamed over the output 625 to the TV.

Mechanisms for Associating the Set Top Box with an Appropriate Barker Channel

Recall that a STB is associated with a barker channel rating, and that this association can be static or dynamic. Further, the barker channel can be provided by the headend on a static or dynamic basis. Once the barker rating for the STB is known, and a barker channel with that rating is streamed, the next step is to enable the STB to access the appropriate barker channel.

Regardless of whether the barker channel is statically or dynamically provided, the STB must be associated with the appropriate barker channel. The STB may be uniquely associated with a barker channel, or a barker channel may be accessed by multiple STBs. In either case, mechanisms are required to inform a particular STB of how to receive the appropriate barker channel. This is essentially accomplished by sending a message to the STB indicating which channel it should tune to in order to receive the barker channel.

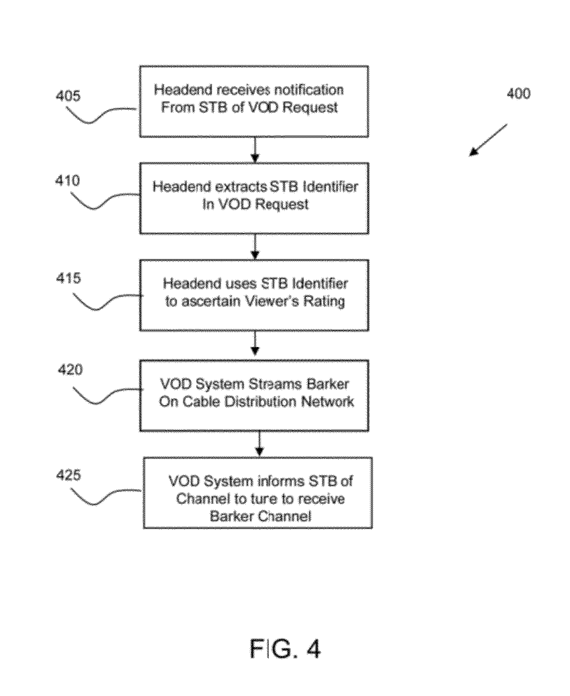

One embodiment occurring in the headend for associating the STB with the barker channel is shown in FIG. 4. FIG. 4, the process 400 begins with the headend receiving notification from the STB in step 405 that the viewer desires to access the VOD service. The VOD management system may receive the notification and may inform the BMS (see, e.g., FIG. 2). As noted previously, in other embodiments the VOD management system and the BMS may be integrated.

The VOD service request sent from the STB may include a STB identifier. In other embodiments, the STB identifier can be sent as a separate message. The STB identifier is uniquely associated with the STB, and allows the headend to access the viewer's information used to determine the barker channel rating. This information may comprise past billing information, movie selections, viewing habits, demographics information, etc. In one embodiment, the STB identifier is assumed to correlate uniquely with the viewer, and thus there is equivalence (to a degree) between the STB identifier and viewer. For households having multiple viewers, other embodiments described later may be used to identify a viewer's rating.

The viewer's information in step 415 can then be used to ascertain the barker rating that the viewer is associated with. In summary, at this point of the process in FIG. 4 the STB identifier is known and used to determine the barker rating.

Next, in step 420, the headend streams the appropriate barker channel over the distribution network. The streaming may already have been established (as in the case of a static barker channel) or the streaming may just have been initiated (as in the case of a dynamically generated barker channel). In the latter case, the BMS creates a playlist for the barker. In step 425, the VOD system informs the STB of which channel to tune in order to receive the barker channel. Typically, the STB is informed of which channel to tune to after the headend begins streaming the barker channel. This avoids the possibility of having the STB tune to an unused channel which can occur if there are difficulties in generating the barker channel.

Variations are possible in the embodiment shown in FIG. 4. One variation pertains to providing static barker channels. Once the STB knows what channel the appropriate barker channel is located on, this information could be retained by the STB so that the next time the user invokes the VOD service, the STB automatically is aware of the appropriate barker channel to access. In other variations, the headend periodically informs the STB of the appropriate barker channel. This can occur by using well known carouseling techniques during off-hours. The STB would then be programmed to use the appropriate static barker channel when the user accesses the VOD service or electronic program guide. The STB could be further programmed so that if this information is not available, then the default channel is can be used. In other embodiments, the headend could generate a customized barker channel for a viewer only if there is available channel space. If there is insufficient channel capacity in the video distribution system at the moment, then the headend could inform the STB to use the default barker channel. This illustrates two applications of the default barker channel, which can be used to accommodate unusual circumstances prohibiting providing a custom barker channel.

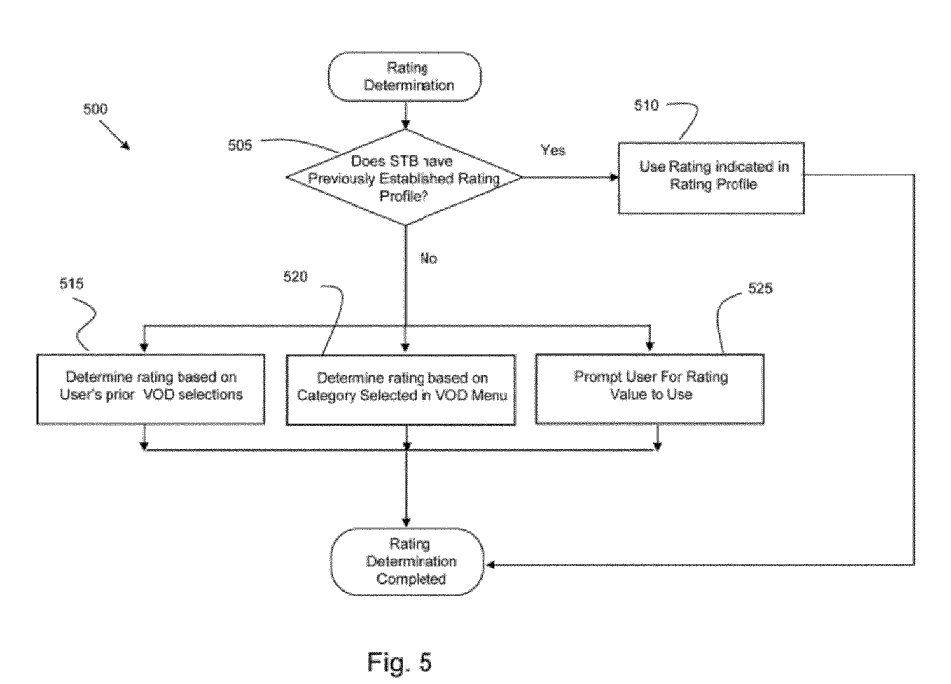

The step of ascertaining the viewer's barker channel rating in step 415 of FIG. 4 can occur in different ways. One embodiment for accomplishing this is shown in FIG. 5. In FIG. 5, step 505 depicts the headend initially determining whether the viewer has previously established a barker rating profile. This could have been established at service provisioning, by the viewer editing a subscriber's service profile at a web site, interacting with an application module executing in the STB communicating a viewer's rating preference to the headend, etc. The information can be initially indicated in a number of ways. If there is a rating profile established, then the headend uses that value in step 510. Determining the rating may be as accomplished by performing a simple table lookup operation in the headend using the STB identifier. The rating profile may be incorporated into a subscriber's service profile, which contains various other service related information.

If there is no rating profile previously established for the viewer, then three other embodiments for determining the rating are shown. In step 515, the headend determines the viewer's rating by analyzing past VOD program selections of that user. This information can be retrieved from a billing system or from a transaction history log of prior movie selections. One algorithm could ascertain which is the most frequently selected rating of the last ten movies selected by the subscriber. For example, if 90% of the last ten selected movies where rated PG-13, then a PG-13 barker rating could be used. Because this would be based on a moving average (the last ten movie selections), changes in movie selections would influence the rating of the barker channel associated with that viewer. Various other algorithms can be defined to determine the rating.

For example, in another embodiment, the STB records data related to which non-VOD programs are viewed by the viewer. This could include data indicating every channel viewed, comprising date, start time, channel identifier, and end time (alternatively to storing the beginning and ending time, the duration could be recorded). Other information could include program meta-data in addition to, or in lieu of, the channel information, the set top box identifier, etc.

The data provides a viewing history of the viewer. In one embodiment, the STB periodically sends the data to the headend, which analyzes the data to ascertain viewing preferences of the viewer. In another embodiment, the invocation of the VOD service triggers the STB to transmit the viewing records data to the headend, which uses this to determine barker content for the user. Other variations as to when the data is sent to the headend are readily possible. The data can be stored in a database in the headend, for analysis during “off-hours.” In one embodiment, the data is stored in accordance with a SCTE 130 Subscriber Information System (“SIS”) format.

Step 520 is another approach for selecting the barker channel rating. This is based on using the selected category that the viewer selects in the VOD menu to determine a rating. Specifically, when the viewer initially enters the VOD menu, the viewer can be presented with a list of categories (action, drama, comedy, children, etc.). After the user selects a category (e.g., “children”), this information is conveyed to the headend that uses this information to limit the barker rating information. For example, after requesting to view movies in the “children” category, a Grating for the barker channel can be established. However, if the viewer selects a comedy, then another rating level could be determined, e.g., a PG-13. Further, if an action movie is selected, it could be another level, e.g., R rated.

The criteria used to determine the barker rating could be further modified based on a time of day, day of week, demographic information, past purchasing information, etc. Thus, the BMS could use multiple data sources to analyze and select the appropriate barker rating for a viewer. For example, an action movie category selected before 9:00 p.m. may result in the viewer associated with a barker channel having a PG rating, but an action movie category selected after 9:00 p.m. may be associated with a PG-13 rating. (This is based on the assumption that young children in the household will not be viewing the VOD menu barker content after 9:00 p.m.) Demographic information can be used to impact the analysis. For example, information indicating that the viewer's household comprises children can be used to invoke the above selection rule whereas information indicating that no children are present in the household can be used to apply a different rule for determining the barker rating.

Another approach for selecting the rating of the barker content is shown in step 525. In this approach, the user is prompted via an on-screen menu as to what rating value and/or type of content should be assigned. The prompting could occur upon initial installation of the set top box, and/or can occur periodically (e.g., one a month or some other time period). The prompting can be accomplished by the STB generating a display comprising various menu prompts, which can be selected using the remote control. The rating value indicated can be stored locally in the STB and/or communicated to the headend. The headend can then update a rating profile for the viewer, or otherwise use the information with other data to determine the barker content.

In other embodiments, viewer input could be obtained from viewer feedback. This could include rating information provided by the viewer after watching a movie, viewer responses to search and/or recommendation engines associated with the VOD, or applications allowing viewer creation of a “favorites list” of movie titles.

### Signaling Mechanisms for Associating A Set Top Box With A Barker Channel

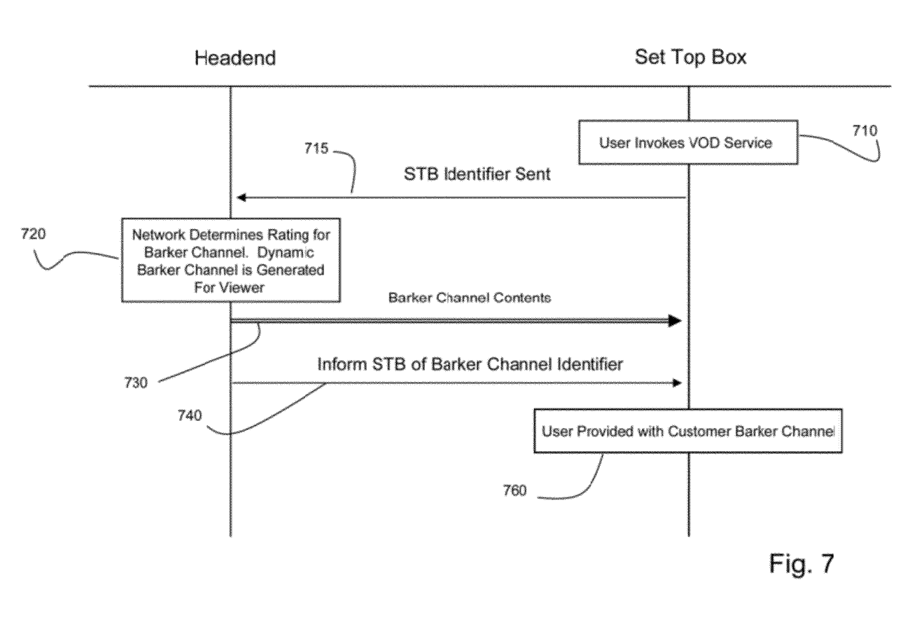

The signaling mechanisms for associating a STB with a particular barker channel involve (1) identifying the particular STB, and (2) communicating the appropriate channel identifier to the STB so that it can access the customized barker channel. One approach involves using proprietary signaling communication between the headend and the STB. This approach lends itself to adapting the existing VOD Management System to use new/existing signaling messages. Presently, VOD signaling has the capability of conveying a STB identifier from the STB making the VOD request, and generating messages instructing the STB to tune to a specified channel. These signaling mechanisms can be adapted for indicating which barker channel the STB should receive. This does require a modification to the software applications in the STB so that it can substitute the appropriate barker channel upon receiving instructions. One approach for doing so is shown in FIG. 7, and does not limit the possible network architectures that can be used to embody the invention by the CSP.

In FIG. 7, the user invokes the VOD service using the remote control at step 710. The service invocation causes a message 715 to be sent from the set top box to the headend indicating the STB identifier. This STB identifier uniquely identifies the set top box and is already incorporated in the STB for other service applications. Upon receipt, the headend in step 720 uses the STB identifier to ascertain viewer specific information to determine a barker rating. For purposes of illustration, a single viewer service profile is presumed to exist at the service location. Other embodiments, as will be seen, can allow several viewer profiles associated with the service location. In such embodiments, additional information may be required to identify a specific profile if there are multiple profiles associated with the service location.

Once the headend is able to ascertain the viewer's identity using the STB identifier, then additional information can be retrieved by the headend is associated with the viewer to aid in determining a rating of the barker channel for that viewer. As discussed earlier, this can be based on an explicit service profile established for that viewer, by analyzing past selections of the viewer, or by analyzing viewer demographics and third party data sources. Whatever means are used, the headend is able to ascertain a rating appropriate for the viewer in step 720. The headend further invokes procedures to create the custom barker channel (if it is not already being streamed) and streams the barker channel 730 to the set top box. This architecture can accommodate either a static or dynamic barker channel.

Next, in step 740, the headend informs the STB of the appropriate channel to tune to, so that the STB can receive, process, and display the custom barker channel. In step 760, the custom barker channel is presented to the viewer.

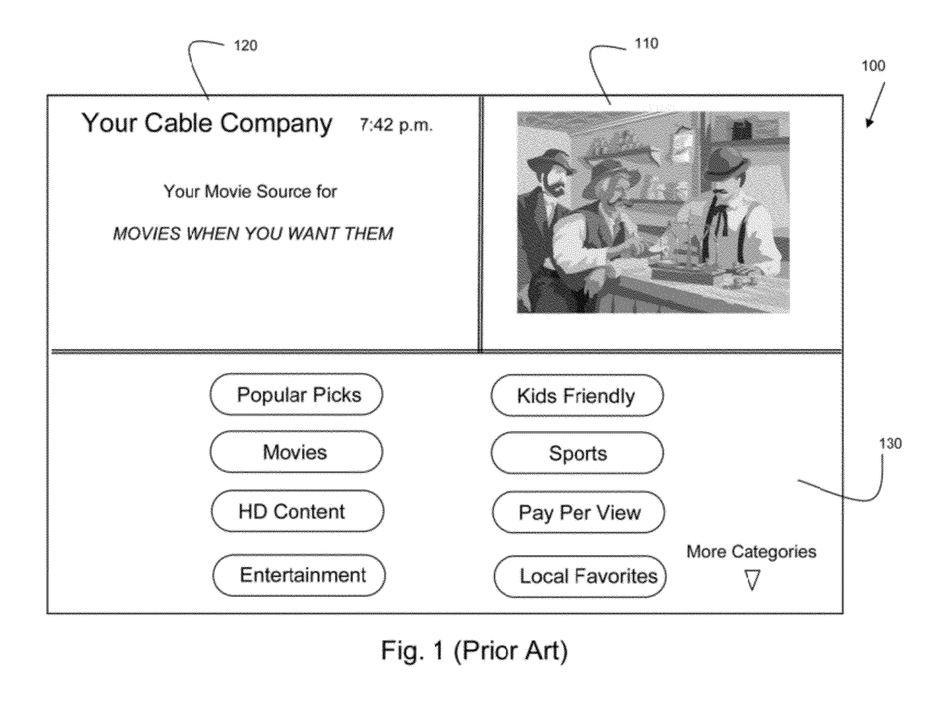

The STB maybe programmed to process the barker channel contents into the appropriate window pane, such as window pane 110 shown in FIG. 1. In other words, the VOD module in the STB receives the barker channel and locally generates the menu options creating the composite display similar to that shown in FIG. 1.

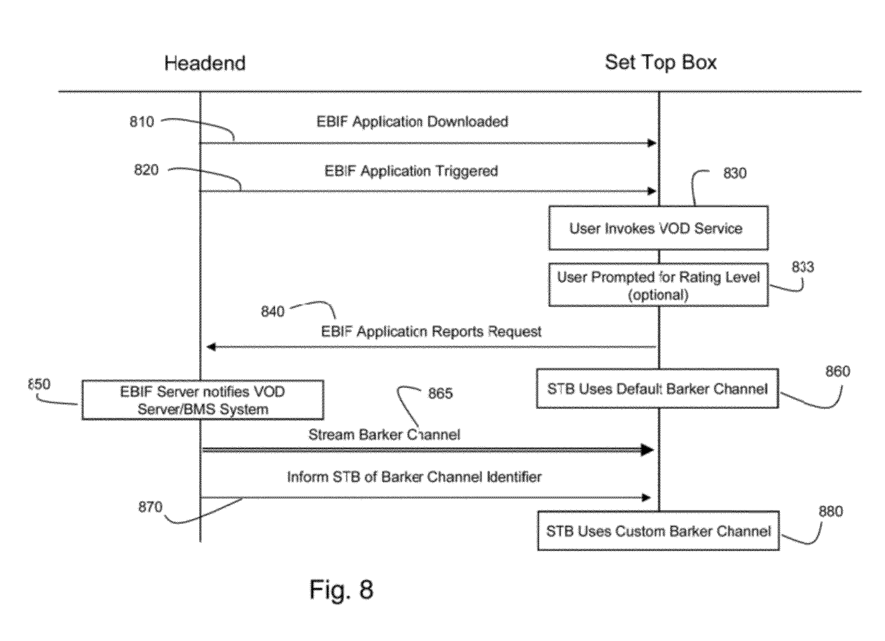

Another signaling approach relies upon providing an Extended Binary Interchange Format (“EBIF”) application to the STB. EBIF is a signaling mechanism for providing interactive television services. It relies upon the STB implementing a client application that is capable of receiving a program, and executing the program when instructed. The client application can also prompt the user for input, such as for an explicit barker rating indication. One embodiment involving the use of EBIF applications is shown in FIG. 8.

In FIG. 8, an EBIF application is downloaded in step 810 to the set top box. This application can be sent periodically at off-peak-hours to the STB, such as early morning. Further, the EBIF application trigger can be sent in step 820, causing the application to start executing, so that the applications are present and executing in the STB.

At some point later, the viewer invokes the VOD service in step 830. This is accomplished in a variety of well known ways using the remote control. At that point, the EBIF application executes a prompt for the user in step 833, such as: “Please enter a rating to be used for previewing movie trailers.” This step is optional, as the headend may be able to determine this using one of the aforementioned techniques. In step 840, the EBIF application reports the VOD service request and/or the rating indication. The message 840 may further indicate the STB identifier.

In step 850 the headend EBIF server processes the message from step 840 and notifies the VOD Server/BMS system. The headend ascertains the barker rating to be used for that viewer, and in step 865 streams the barker channel over the video distribution network. In step 870 the headend informs the STB of the barker channel identifier. Finally, in step 880, the STB tunes to the indicated barker channel to receive the barker.

### Barker Management System Architecture

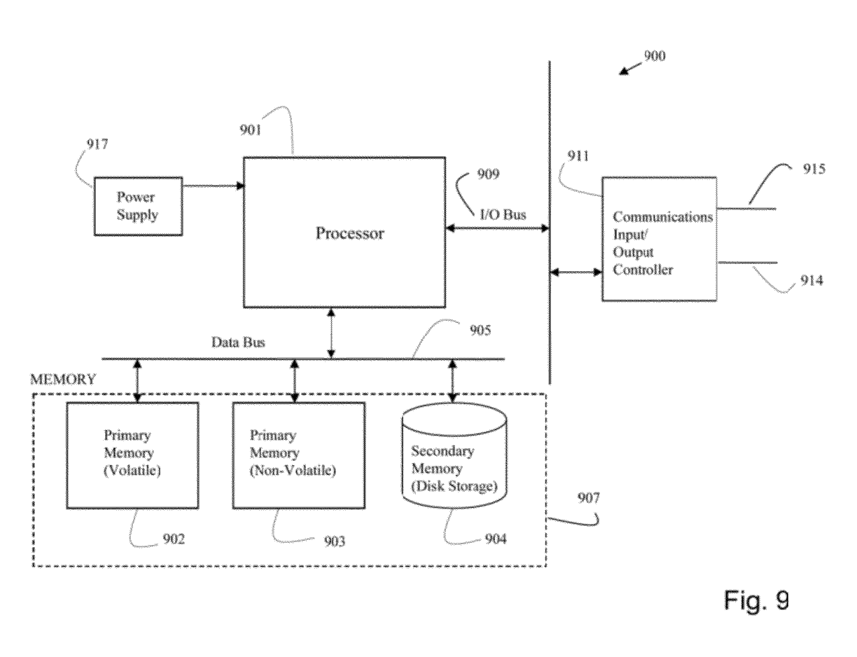

One embodiment of the barker management system (“BMS”) 250 previously discussed in conjunction with FIG. 2 is further illustrated in FIG. 9. FIG. 9 illustrates one embodiment of the BMS 900, which comprises a processor 901 receiving power from a power supply 917. The processor is in communication with a memory storage system 907 using a data bus 905. The memory storage system 907 comprises primary memory 902, 903 and secondary memory 904. The primary memory can comprise RAM 902 type memory, which can be of various forms (DRAM, SRAM, etc.) that are well known in the art. The primary memory can also comprise non-volatile memory 903, which can comprise EEPROM, EPROM, Flash type memory, and other forms well known in the art. Finally, the memory storage can also comprise secondary memory 904, which is suited for long term storage of large amounts of data, including the movie trailers.

Typically, the primary memory is used to store computer application code, which is executed by the processor. Specifically, the program executed by the processor 901 is for carrying out the steps of the present invention and the program can be stored in secondary memory and loaded into primary memory as required. Other associated programs and data are stored in memory as required. The barker video asset can be stored in the disk storage 904 element, or may be stored in a separate VOD video asset storage device.

The processor 901 also communicates using an input/output (“I/O”) bus 909 with an I/O controller 911, which in turn is configured to send/receive data from other entities. The I/O controller in one embodiment may offer an interface 914 to an enterprise LAN (not shown) which allows the BMS to communicate with the VOD system, and various other databases, indicating: demographic data, user movie selection data, billing data, etc. Other interfaces 915 can be used for transmitting the customized barker channel message over an interface 915 connected to the cable headend multiplexor.

FIG. 9 represents only one possible embodiment of the BMS system shown in FIG. 2. In some embodiments, the functions of the BMS system can be integrated with the VOD system. In this embodiment, the application programs of the BMS system can be stored and executed on the VOD platform, or the functions of the application programs can be implemented as modifications to the programming of an existing VOD system. Those skilled in the art will readily recognize a number of variations are possible, which offer respectively different advantages depending on which factors are more important in a given implementation.

### Customized Barker Embodiments Based on SCTE 130

The SCTE 130 suite of standards provides defined interfaces to various system components for the purpose of dynamically replacing/inserting advertising into linear programming or on-demand programming. A SCTE 130 based architecture can be adapted to allow further service variations on providing a customized barker channel to a viewer.

In one service variation, a customized barker channel can be provided based on providing viewer specific text and/or graphic overlays, banners, or text “crawls.” These can be collectively termed “overlays” and refer to information that is displayed over the barker channel in various ways. The overlay information can be semi-transparent (allowing portions of the barker contents to be seen), or opaque. Thus, the default barker channel can be customized by placing a custom overlay on the barker and unicasting the result to a specific viewer. The overlay can inform the user of certain relevant information for the particular movie trailer being featured in the barker. For example, the overlay could inform the viewer that the promoted movie shares the same producer as a movie previously selected by the viewer. This overlay would be specific to the instant movie trailer being shown, and could be specific to the viewer. However, these aspects are not required in all embodiments of providing overlays. Those skilled in the art will recognize that overlays can present information to the viewer of different facts, offers, discounts, promotions, etc.

In another embodiment, the same default barker channel can be customized by inserting and transmitting a specific EBIF application for that user. This approach involves processing the default barker channel by inserting a viewer-specific EBIF application and then unicasting the barker channel to a specific viewer. Thus, in these two variations, a custom barker can be created even though the same movie trailers presented to the viewer are the same as in the default barker. In one example, if the cable service provider knows that the viewer is a frequent consumer of science fiction movies, then an EBIF application can be sent, for example, to offer information about an upcoming science fiction movie, movie discounts, or solicit viewer feedback.

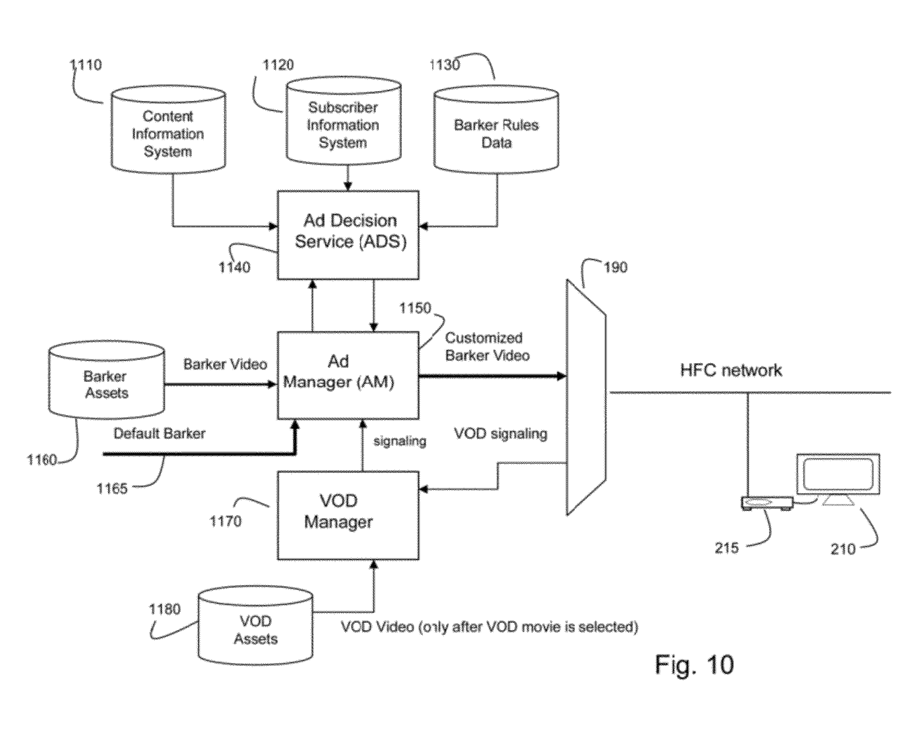

One architecture for providing a custom barker to a viewer is shown in FIG. 10. This embodiment uses various SCTE 130 based functional components. SCTE 130 is recognized by those skilled in the art as an approach to provide interactive advertisements in video programs offered by a video service provider. This embodiment is based on providing a custom barker where the movie trailers are different from the movie trailers offered in the default barker. In this embodiment, certain movie trailers may be added to the default barker channel, or used to replace certain movie trailers. Thus, this system can provide the aforementioned dynamic barker channel to a user where the contents are different relative to the default barker channel.

In the embodiment of FIG. 10, the Ad Manager (“AM”) 1150 is responsible for streaming the custom barker to the multiplexer 190 and other distribution related equipment. The Ad Manager receives the default barker video 1165 from a barker asset source. The default barker comprises SCTE 35 based cues (called Digital Program Insertion Cues) indicating where individual trailer content begins/ends. The Ad Manager processes these messages and knows where the movie trailers are located. The Ad Manager queries the Ad Decision Service (“ADS”) 1140 for which content should replace (if at all) a movie trailer. The Ad Decision Service may consult various information sources to make this determination.

The Ad Decision Service 1140 may consult a Content Information System (“CIS”) 1110 which stores information about the content of a particular asset, such as a movie trailer. This may include rating information, so that the Ad Decision Service is aware of the rating of each movie trailer that may be transmitted to the viewer. The Ad Decision Service may access information in a Subscriber Information System (“SIS”) 1120, which stores information about a particular viewer. Thus, to the extent that the Ad Decision Service requires viewer specific information about the viewer's rating, prior selections, etc., that information is readily available. Finally, the Ad Decision Service may access a Barker Rules database 1130. This database may store rules about which movies trailers are to be featured and when, how time of day is to be considered in selecting content, other selection rules, etc. Thus, upon detecting an SCTE 35 Digital Program Insertion Cueing Message, the Ad Decision Service can access a database to determine the nature of the content that is upcoming (including its rating), the rating profile of the subscriber and past viewing history, and applicable rules as to how the information is to be applied. For example, the Ad Decision Service will know:

that a particular viewer may be presented with PG rated movie trailers,

the next movie trailer to be presented in the default barker channel has an R rating,

the set of available movie trailers in the barker asset database having PG rating, and

which particular movie trailers are to be promoted for this time of day.

This information can be used by the Ad Decision Service to then inform the Ad Manager as to which barker asset in the barker asset store 1160 should be selected to replace an existing movie trailer.

With this understanding, the process flow associated with FIG. 10 can be described. The viewer selects the VOD service at the STB 215, which sends a signaling message requesting the VOD service to the VOD Manager 1170. This request includes the STB identifier so that the appropriate subscriber (viewer) can be identified. The VOD Manager then informs the Ad Manager 1150 of the request, including the STB identifier. While the Ad Manager is responsible for generating the customer barker channel to the viewer, it does not know what content to use.

In one embodiment, the Ad Manager receives the default barker, and essentially unicasts the default barker contents unchanged if the contents are acceptable, and replaces the barker contents (e.g., a particular movie trailer) if the contents are unacceptable from a rating perspective. Other embodiments may use other criteria such as the type of content for replacing contents of the default barker channel.

While the Ad Manager is responsible for streaming the content of the custom barker channel, in this embodiment it does not make the determination of which content to provide. Rather, the Ad Manager relies on the Ad Decision Service to inform it of the appropriate content. Thus the Ad Manager essentially asks the Ad Decision Service as to whether the movie trailer in the default barker is acceptable or not.

The Ad Manager informs the Ad Decision Service of the VOD request originating from the viewer. The Ad Manager also informs the Ad Decision Service of the current barker movie trailer. This is accomplished by informing the Ad Decision Service of the asset identifier of the present (or upcoming) movie trailer on the default barker. Thus, the Ad Decision Service knows which viewer made the VOD request and the nature of the current movie trailer available on the default barker. The Ad Decision Service determines the viewer's rating profile by accessing the SIS database 1120 for subscriber specific information. This includes past viewing selections, rating profiles, demographic information, etc. Further, the Ad Decision Service determines the content, rating, and other required information about movie trailer in the CIS 1110. Finally, Ad Decision Service may access another database, called the Barker Rules database 1130, which can have campaign-like data indicating which movie trailers are to be favored, when they should be shown, rules about selecting the movie trailer, algorithms for selecting a rating based on past subscriber viewing habits, etc. For example, a movie trailer for a newly released PG rated movie should not be previewed before, or after, certain dates. Further, the Barker Rules database may indicate how to favor (or disfavor) selection of particular types of content based on time of day, day or week, or other criteria.

After the Ad Decision Service has analyzed this information, it informs the Ad Manager as to whether the Ad Manager should use the present contents of the default barker or retrieve a replacement barker asset (e.g., movie trailer). If a replacement movie trailer is indicated, the Ad Decision Service provides the asset identifier to the Ad Manager, and the Ad Manager obtains the asset from the barker asset store 1160. The AD Manager then unicasts the appropriate barker contents on a channel to the viewer.

The STB must be informed of the unicast channel, and two embodiments are disclosed for accomplishing this. First, the Ad Manager can initiate a signaling message to the STB as to the appropriate channel, or the Ad Manager can inform the VOD Manager, and the VOD Manager issues the message. The latter approach leverages the messages that are used in the VOD service for informing the STB of a channel to receive a VOD program.

Other embodiments are possible. For example, in another embodiment, the VOD Asset database 1180 can be used to store the barker assets and/or the default barker asset. Otherwise, the VOD Asset database 1180 is not required for streaming barker contents.

In the above embodiment, the movie trailers in the default barker can be replaced as required to ensure that the ratings comport with the desired rating profile of the viewer. In other embodiments, the Ad Decision Service can select movie trailers to replace existing movie trailers so as to target the content for a particular viewer. Thus, this SCTE 130 based architecture can be used to provide the service variations previously described.

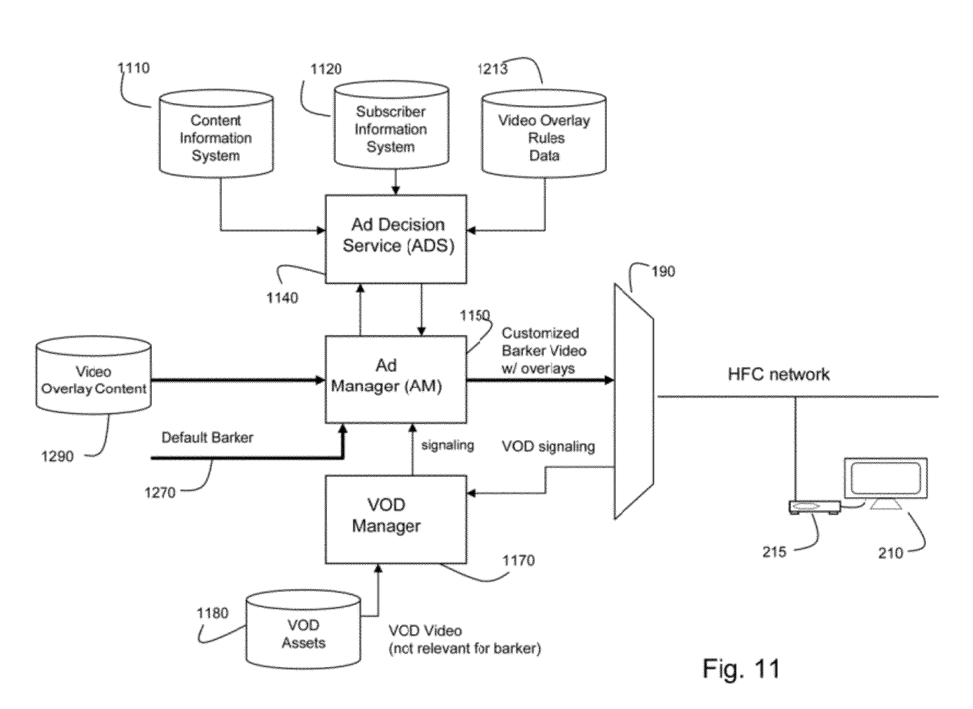

FIG. 11 illustrates an alternative embodiment for providing a customized barker channel. In this embodiment, the default barker channel is processed to add a digital overlay onto the barker, which is then unicast to the viewer. In this manner, a custom barker channel is generated even though the movie trailers are the same as in the default barker channel.

In FIG. 11, the Ad Manager provides the customized barker to the viewer. This is accomplished by receiving the default barker 1270 and adding the appropriate video overlay content, which is obtained from video overlay content database 1290. The Ad Manager is informed by the Ad Decision Service as to which overly content to obtain from database 1290, and when/how to overlay it. The Ad Decision Service obtains the required data to make this determination from the CIS 1110, the SIS, 1120, and a Video Overlay Rules Database 1213. These sources provide the necessary data for the Ad Decision Service to appropriately instruct the Ad Manager. Other aspects are similar as discussed in conjunction with FIG. 10.

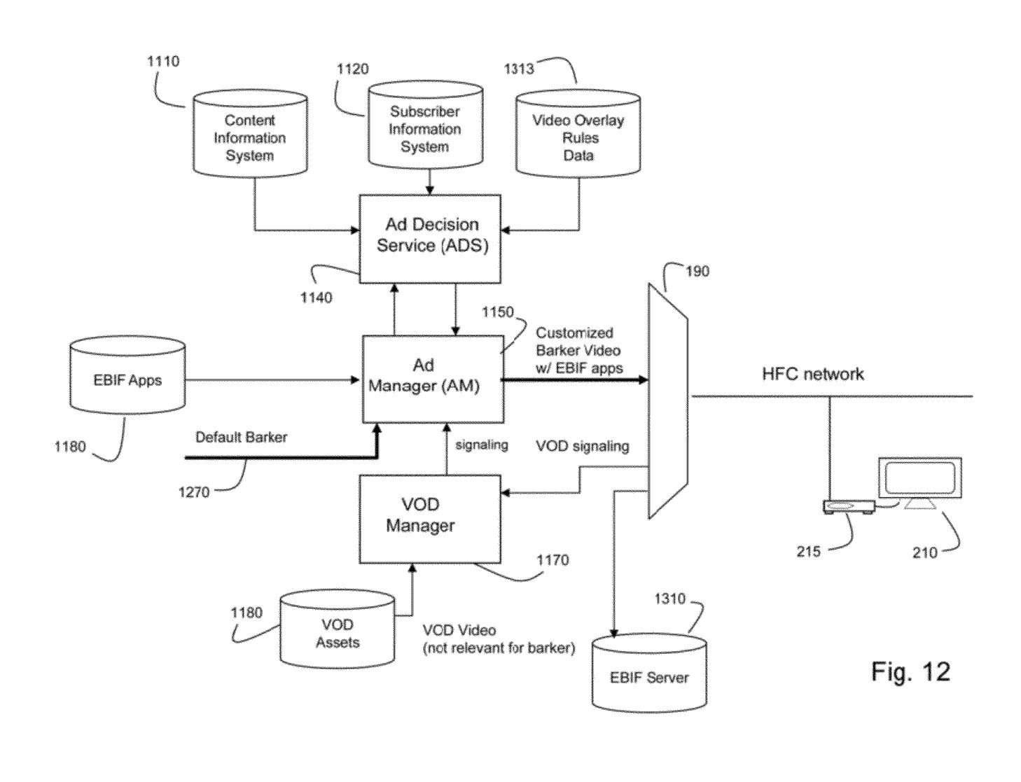

FIG. 12 illustrates another embodiment for providing customized barkers. In this embodiment, the architecture provides the default barker channel on a unicast basis to a viewer, but inserts an EBIF application for that specific viewer. The EBIF application may provide on-screen displays, similar in scope as digital overlays, and/or can prompt the user for input.

The EBIF application could indicate information specific to the movie trailer in which it is inserted, and/or indicate information specific to the viewer. The contents of the information can vary, and can solicit a response. Responses are received and processed by an EBIF Server 1310.

A review of the message flows in FIG. 12 will further describe its operation. The viewer at television 210 interacts with the STB 215 by using the remote control to select the VOD service. The STB indicates the request and the STB identifier to the VOD Manager 1170. The VOD Manager informs the Ad Manager of the need to provide a custom barker channel to that viewer.

The Ad Manager receives the default barker 1270, and begins unicasting it on the hybrid-fiber coax network to the viewer. A mechanism is required to inform the STB to tune to the appropriate channel to receive the unicast barker. This may occur by the by the Ad Manager informing the VOD Manager of the appropriate channel, which and in turn, informs the STB. The result is that the STB is informed of the unicast custom barker channel and uses it as the VOD service barker.

The Ad Manager then requests the Ad Decision Service for an appropriate EBIF application to insert into the unicast stream. The Ad Manager may inform the Ad Decision Service of the current movie trailer being streamed, and of the STB identifier. The Ad Decision Service then accesses the various data sources 1110, 1120, and 1313 to ascertain the proper EBIF application to insert. Once this is determined, the Ad Manager is told which EBIF application to retrieve from the EBIF Application data store 1180, and inserts the EBIF Application into the barker. The EBIF application must also be “triggered” and this can be done by the Ad Manager under its own control, or under the direction of the Ad Decision Service, or some other entity. Once the EBIF application is transmitted to the STB and triggered, it is executed by the STB.

The EBIF application can display prompts, and receive user input. The EBIF application could merely display information for a limited time to the viewer, or it could display information and solicit a prompt. For example, the EBIF application could indicate to the viewer that the presently promoted movie on the barker channel has just been made available, and if ordered now, a discount will be received. Further, the EBIF application could prompt the viewer, such as “Do you want to order this movie now?”. The response to the prompt is conveyed from the STB to headend, where is it received by and EBIF Server 1310. The EBIF Server 1310 could provide the data to a separate processing system that then causes the VOD manager to play the movie, provides a discount for selecting a movie, etc.

The SCTE 130 architecture is a flexible architecture, and it can be used with various configurations for implementing one or more of the above service functionalities. Those skilled in the area of using SCTE 130 for designing interactive TV applications will readily appreciate that other variations are possible for providing customized barker channels to a viewer.

### Various Embodiments

As will be appreciated, other variations are possible on the previously identified embodiments illustrated. For example, the above description presumes that a viewer can be uniquely identified by the unique set top box identifier. It is quite common for a household to have multiple set top boxes, and have multiple individuals in the household watching television programs, so it may be desirable to further define which rating should be assigned to a particular STB.

Another approach for assigning a rating to a viewer is to assign a common rating to all viewers in the household (which is functionally the same as assigning the rating to the household or service account). Thus, a household having two different STBs (and hence two different STB identifiers) would be treated identically. This can be accomplished by copying the rating established for one STB in a household for the rating for the other STB in the same household. Since the CSP is aware of all the STBs associated with a household, this action can be readily accomplished by appropriate programming of the BMS system.

One approach is to associate a rating to a specific set top box in a household, so that each set top box has its associated rating. This approach can accommodate a household with two set top boxes, one which is primarily used by children and/or family members in general, and another which is limited to use by the parents. Allocating a rating to each STB allows two different barker channel ratings to be used. Alternatively, the program content selection of a VOD program can be assigned to a particular set top box. This allows the STB viewed by children to only feature G rated barker trailers or otherwise feature content targeted to children.

Another approach for assigning barker channel ratings and/or content is to assign a value for each particular viewer. This requires a procedure for ascertaining the identity of the viewer upon accessing the VOD service. Because the viewer can change with each viewing session, a mechanism is required to alter this value on an as-needed basis. Thus, one approach involves prompting the viewer for a viewer identifier, which was discussed in conjunction with FIG. 8. In another embodiment, rather than prompting the viewer for a rating value (which children could easily circumvent), a secret code or viewer identifier could be entered. This allows, for example, parents to have a secret code to allow R rated barker channels to be presented when they use a STB, and another code for young children to use that provides G rated barker channel. Those skilled in the art will appreciate that variations are possible for allowing individualized barker channels to be associated with a viewer, STB, or household.

As noted before, the principles of the present invention can be used to select specific trailers for particular households based on content type of the trailer: as opposed to, or in addition to, the rating of the content. Specifically, the type content (comedy, documentary, drama, action, animated, etc.) can be used as the selection criteria. In other embodiments, the subject matter of the trailer (warfare, travel, football) can be used as the selection criteria. In some embodiments, the selection of the content by type or subject matter can impact the rating indirectly. For example, the principles of the present invention can be used to select trailers featuring child friendly program trailers for a particular STB. The selection based on content (e.g., animated cartoons) may provide a de facto presentation of trailers having a certain rating (e.g., G rated trailers). Thus, selection by type of content can be equivalent in some cases to selecting trailers based on rating.

In other embodiments, selection of trailers based on content may not be equivalent to selection of trailers based on rating. For example, the principles of the present invention can be used to exclusively provide “action” type trailers to a particular viewer. These types of trailers may be variously rated PG, PG-13 or R. Selecting trailers based on content provides another form of a customized barker channel to the viewer. Further, combinations of criteria can be used. For example, a viewer may have “action” type trailers provided to them on a barker channel where after 10 p.m. the ratings may be R rated. However, before 10 p.m., only “action” type trailers are provided with a PG or PG-13 rating. If demographics data indicates that the household has children, then the selected rating may be further limited to G or PG rated trailers.

Finally, selection of which trailers are presented to a viewer can be based on the viewer's billing history. A premium viewer (one that spends, e.g., over a certain threshold each month on video programming) could be provided with certain trailers having a longer, more in-depth promotion of a movie (“extended trailers”). In other embodiments, the premium viewer could view actual portions of the program (e.g., the first 20 minutes of movie). This embodiment provides certain viewers with trailers not normally available to other viewers.

Further, the set top box is not limited to a cable set top box used in a cable system. The set top box can be considered as a device used to terminate video information distributed by a distribution network, providing security, and generating signals commonly received by a television. Hence, the set top box can be a device used in satellite, wireless, or other forms of video distribution. Thus, other variations are possible using the principles disclosed herein, and the invention is only limited by the claims that follow.

Finally, as noted, the principles can be applied for barker channels provided on a stand-alone basis, or barker channels combined with electronic program guides or other such services.

Further, although the invention is described in terms of a cable service provider and a cable subscriber as the viewer, the principles of the present invention can be applied to a variety of technologies and service providers, including satellite television service providers, video service providers using optical telecommunications distribution facilities, or fixed/mobile video delivery.

1. A system for providing customized barker content to a subscriber of a video service provider, comprising:
a set top box (“STB”) connected to a video distribution system of said video service provider, said STB configured to provide signals to a television to present a display associated with a video on-demand (VOD) service; wherein said display comprises a first portion comprising a movie trailer and a second portion comprising VOD menu selections;
a headend configured to stream a plurality of barker channels on a video distribution network, wherein one of said barker channels comprises said movie trailer, said headend comprising:
a processor configured to:
(a) receive a set top box identifier uniquely identifying said set top box, said set top box identifier associated with said subscriber,
(b) cause said movie trailer to be streamed over said video distribution network on one of said plurality of barker channels, wherein said one of said plurality of barker channels is associated with a barker channel identifier, and
(c) inform said set top box of said barker channel identifier; and
a data store, said data store storing said plurality of movie trailers, wherein said processor causes said data store to provide said movie trailer to said video distribution system.

2. The system of claim 1 wherein said STB is configured to send said STB identifier to said headend in response to said subscriber selecting said VOD service.

3. The system of claim 2 wherein said headend simultaneously transmits a plurality of barker channels wherein said one of the plurality of barker channels is associated with a rating.

4. The system of claim 3 wherein said plurality of barker channels comprises a first barker channel having a G rating and a second barker channel having a PG or PG-13 rating.

5. The system of claim 1 wherein said processor is further configured to select said movie trailer based on rating data associated with said set top box identifier.

6. The system of claim 3 wherein said processor is further configured to select said movie trailer for said subscriber to include in said one of a plurality of barker channels, wherein said movie trailer is associated with said rating and said STB is associated with said rating.

7. The system of claim 6 wherein said processor is further configured to determine said rating by determining prior VOD selections originating from the STB by retrieving data indicating prior VOD selections originating from the STB from said memory store.

8. The system of claim 6 wherein said processor is further configured to determine said rating associated with said. STB identifier by retrieving a service profile associated with the STB identifier.

9. The system of claim 1 wherein said processor is further configured to cause a movie to be streamed from said headend to said STB in response to a request for said movie sent from STB associated with said VOD service.

10. The system of claim 1 wherein said processor is configured to select said movie trailer from among a plurality of movie trailers based on both content of said movie trailer and demographic data associated with said STB identifier.

11. A method for providing customized barker content to a set top box (“STB”) of a subscriber of a video service subscriber, wherein said STB is configured to generate signals to a television for a display having a first portion presenting a movie trailer and a second portion presenting VOD menu selections, said method comprising the steps of:
receiving a signal at a headend of the video service provider sent from the STB over a video distribution network indicating a set top box identifier, wherein said signal is sent in response from said subscriber requesting a video on-demand service;
selecting said movie trailer from a data store storing a plurality of movie trailers having a plurality of ratings;
causing said movie trailer to be streamed from said headend over one of a plurality of barker channels; and
providing to said STB from said headend a barker channel identifier associated with the one of the plurality of barker channels, wherein said STB generates said display by accessing said barker channel using said barker channel identifier.

12. The method of claim 11 wherein said movie trailer is selected based on a content of said movie trailer and prior VOD movie selections by said STB.

13. The method of claim 11 wherein said signal is based on an extended binary based interchange format (“EBIF”) message.

14. The method of claim 11 wherein a rating of said movie trailer is the same rating associated with a rating profile associated with said subscriber.

15. The method of claim 11 wherein a rating of said one of said plurality of barker channels is the same as a rating of said movie trailer.

16. The method of claim 15 wherein at least two of the plurality of barker channels have different ratings.

17. The method of claim 16 wherein a processor is configured to select said movie trailer based on rating data associated with said set top box identifier.

18. The method of claim 17 wherein said rating of said movie trailer is the same as a second rating associated with said STB identifier.

19. The method of claim 18 wherein said processor is further configured to determine said second rating by analyzing prior VOD movie selections indicated by said STB.

20. The method of claim 18 wherein said processor is further configured to determine said second rating by accessing a viewer profile associated with said STB.

21. A system for providing customized barker content to a subscriber, comprising:
an SCTE 130 based Ad Manager (“AM”) receiving a default barker comprising a plurality of movie trailers, and further configured to provide said customized barker content;
an SCTE 130 based Ad Decision Service (“ADS”) interfacing with said AM, said ADS configured to receive a request from the AM to identify custom barker data for the AM to incorporate into said default barker to provide said customized barker content;
an SCTE 130 based Content Information System (“CIS”) storing content information about at least one movie trailer of said default barker, said CIS configured to provide said content information to said ADS; and
an SCTE 130 based Subscriber Information System (“SIS”) storing subscriber information about said subscriber, said SIS configured to provide said subscriber information to said ADS,
wherein said ADS uses said content information and said subscriber information to indicate said custom barker data to said AM, and
wherein said AM retrieves said custom barker data from a data store and generates said customized barker content to said subscriber using said custom barker data.

22. The system of claim 21 wherein said custom barker data comprises overlay data.

23. The system of claim 21 wherein said custom barker data comprises a replacement movie trailer.

24. The system of claim 21 wherein said custom barker data comprises an EBIF application.

25. The system of claim 23 wherein the ADS is configured to communicate with a rules database, receiving an indication from said rules database of a point in time after which said replacement movie trailer can be incorporated into said default barker.

26. The system of claim 21 wherein an indication of a custom barker channel comprising said customized barker content is transmitted to a set top box associated with said subscriber.
